(19) United States
(12) Patent Application Publication
(10) Pub. No.: US 2022/0240539 A1
(43) Pub. Date: Aug. 4, 2022

(54) PROTEIN FROM PEELED TUBERS

(71) Applicant: COÖPERATIE KONINKLIJKE AVEBE U.A., Veendam (NL)

(72) Inventor: Robin Eric Jacobus SPELBRINK, Scharmer (NL)

(21) Appl. No.: 17/613,397

(22) PCT Filed: May 25, 2020
(86) PCT No.: PCT/NL2020/050333

§ 371 Date: Nov. 22, 2021

(30) Foreign Application Priority Data
May 24, 2019 (EP) 19176584.1

(51) Int. Cl. A23J 1/00; A23J 3/14

(52) U.S. Cl. CPC A23J 1/006; A23J 3/14

(57) ABSTRACT

The invention provides a method for obtaining a tuber protein isolate, comprising a) peeling at least one tuber, thereby obtaining at least one peeled tuber and a tuber peel composition; b) processing said at least one peeled tuber to obtain an aqueous liquid comprising tuber protein; and c) subjecting said aqueous liquid to a protein isolation step to obtain said tuber protein isolate. It has been found that peeling potatoes prior to protein isolation has several benefits: the isolated crude protein, or a hydrolysate thereof, is more clean, and has a composition enriched in tyrosine, proline, arginine glutamine, glutamate, asparagine and aspartate. The protein composition obtained from the tuber peels on the other hand is enriched in the essential amino acids threonine, leucine, isoleucine, methionine and phenylalanine.

### BACKGROUND

There is increased demand for vegetarian and vegan analogues of conventional food products, due among others to the increased awareness of the environmental burden which comes with meat-derived food products. However, plant-based protein still cannot compete on various aspects with animal-derived products. One reason is that plant-based protein must often be isolated and processed, prior to being prepared into a food product.

The isolation of in particular tuber protein is a tedious process. Mostly, tuber protein is isolated from starch production waste streams, which are prepared by grinding or mashing whole potato in water and subsequently isolating starch. The process of starch production is described in Grommers et al., Starch: Chemistry and Technology, 2009, 3^{rd} edition, p. 511-539. In the conventional production of tuber starch, the tubers are not peeled, because peeling represents an additional step which is not associated with an advantage for starch production.

The resulting effluent from the starch production process comprises tuber protein, which can be isolated by various methods to obtain native or coagulated protein.

Isolated native or coagulated protein must generally be further processed to remove off-tastes, color and the like. Much effort has also been directed into cleaning the starch production waste stream, in order to remove some of the contaminants prior to protein isolation. In either case however, these processes are laborious, difficult and provide inconsistent results as to the quality of the obtained protein. The present invention provides an optimized protein isolation process, which results in protein with improved characteristics, and which requires less cleaning of the liquid process streams.

### DETAILED DESCRIPTION

The invention is directed to a method for obtaining a tuber protein isolate, comprising

a) peeling at least one tuber, thereby obtaining at least one peeled tuber and a tuber peel composition;

b) processing said at least one peeled tuber to obtain an aqueous liquid comprising tuber protein;

c) subjecting said aqueous liquid to a protein isolation step to obtain said tuber protein isolate.

It has been found that peeling tubers prior to subjecting them to protein removal has several advantages.

First, (crude) protein obtained from peeled tuber is considerably more clean than protein obtained conventionally, from whole (unpeeled) tubers. The quantities of sugars, salts and glycoalkaloids in crude protein obtained from peeled tuber are significantly lower, and the microbiological characteristics of protein obtained from peeled tuber are much better. Thus, less cleaning of the crude protein is required in order to obtain an acceptable final protein product. This increases process efficiency, and decreases the environmental load of the protein product.

Second, protein obtained from peeled tuber has a different composition than protein obtained from whole (unpeeled) tuber. Protein obtained from peeled tubers is enriched in tyrosine, proline, arginine glutamine, glutamate, asparagine and aspartate, which makes such protein, or a hydrolysate thereof, more suitable for use in human food products. This is because a) tyrosine is known to improve human brain function, among which alertness, attention and focus, b) aspartate, glutamate and arginine improve protein solubility and functional properties, among which emulsifying properties and foaming properties, and c) because after protein hydrolysis, the amino acids glutamine, glutamate, asparagine and aspartate are known to be important contributors to umami taste, and the amino acids tyrosine and proline are associated with antioxidant and antihypertensive effects.

Third, a peeling step prior to protein isolation furthermore results in a side stream comprising tuber peels (a “tuber peel composition”). It has been found that protein isolated from the tuber peels is enriched in many essential amino acids, relative to protein obtained from whole (unpeeled) tuber. This includes most notably the essential amino acids threonine, leucine, isoleucine, methionine and phenylalanine.

The term tuber, in the present context, is to be given its regular meaning, and refers to any type of tuber. In particular, tuber in the present definition includes structures which may also be called root. The term “tuber” as herein defined may thus be replaced with the phrase “root or tuber”.

Preferably, a tuber in the present context is an edible tuber, which may be grown in the context of human food production. Tuber inherently comprises protein; preferred types of tuber are also rich in starch, such as tuber used for starch isolation. Tuber protein is understood to mean a single type of protein from one type of tuber, or a particular protein fraction from one type of tuber, although in special cases, tuber protein may comprise a mixture of protein derived from two or more types of tuber.

Preferably, tuber in this context comprises potato (Solanum tuberosum), sweet potato (Ipomoea batatas), cassava (including Manihot esculenta, syn. M. utilissima, also called manioc, mandioca or yuca, and also including M. palmata, syn. M. dulcis, also called yuca dulce), yam (Dioscorea spp), and/or taro (Colocasia esculenta). More preferably, the tuber comprises potato, sweet potato, cassava or yam, even more preferably the tuber comprises potato, sweet potato or cassava, even more preferably the tuber comprises a potato or sweet potato, and most preferably the tuber comprises potato (Solanum tuberosum).

Preferred tuber protein comprises potato protein, sweet potato protein, cassava protein, yam protein, and/or taro protein. Most preferably said tuber protein isolate is a tuber protease inhibitor isolate, a tuber patatin isolate, or a tuber total isolate comprising a mixture of protease inhibitor and patatin. A tuber protein isolate in the present context may comprise native protein or denatured protein. Native protein is protein as it occurs in the tuber of origin. Denatured protein is protein which has lost its natural three-dimensional structure. Denatured protein has the tendency to coagulate to form small particles (“coagulated protein”), which particles can be used in food products, or which can be further processed.

An isolate, in the present context, is a tuber protein obtained from the present method, that is in solution (such as at 0.5-25 wt. %, preferably 3-20 wt. %, more preferably 5-18 wt. %), or after drying in the form of a powder.

The first step of the present method comprises peeling at least one tuber, thereby obtaining at least one peeled tuber and a tuber peel composition. Peeling in this context means removing at least partially the peel of the tuber. The peel is the outer layer or skin of the tuber, which has been exposed to soil in which the tuber was grown. Peeling conventionally comprises not only removal of the skin, but also at least part of the cortex and/or flesh which is present immediately under the skin. Preferably, peeling in the present context means removal of the outer layer of a tuber, wherein said outer layer has an average thickness of 0.2-5 mm, preferably 0.5-3 mm. This results in peeled tubers, which in the present context may also be referred to as tuber flesh.

Many conventional peeling techniques remove only the accessible parts of the peel, that is, peel in for example crevices and steep holes of the potato remains in place. Although such peeling is sufficient to attain at least partially the benefits of the present method, peeling preferably means complete removal of the outer layer of the tuber, that is, the full outer layer which has been exposed to soil during growing.

Peeling of tubers is generally known. Peeling may for example be achieved by the use of a knife to cut away the outer layer. On an industrial scale however, peeling is preferably achieved by mechanical peeling or steam peeling.

Mechanical peeling in this context comprises abrasion, brushing, cutting, rasping, or otherwise mechanical removal of (at least part of) the outer layer of the tuber. Such techniques are generally known.

Steam peeling is also known, and comprises a step of subjecting the tuber to steam in order to remove the outer layer. Steam peeling may be applied in combination with mechanical peeling.

In step b of the present method, at least one peeled tuber is processed to obtain an aqueous liquid comprising tuber protein. Such processing comprises for example pulping, mashing, rasping, grinding, pressing or cutting of the tuber, and optionally a combination with water, in order to obtain said aqueous liquid comprising tuber protein. This aqueous liquid may also be referred to as a tuber juice, or as a tuber processing water.

The tuber juice normally comprises starch, and may be subjected to a step of starch removal, for example by decanting, cycloning, or filtering as is known in the art, to obtain an aqueous liquid comprising tuber protein. In this embodiment, the aqueous liquid is preferably a waste product from the starch industry, for example potato fruit juice (PFJ) as obtained after starch isolation in the potato industry. Preferably, the tuber juice is subjected to a step of starch removal, prior to the protein isolation step.

In other embodiments, the peeled tuber is processed by cutting to form shapes which are the basis for processed tuber products like for example chips and fries. Such cutting, when performed in the presence of water, results in an aqueous liquid comprising tuber protein.

In one embodiment, tuber may be processed by a water jet stream to cut the tuber. In another embodiment, tuber may be processed by cutting knives, for example in the presence of water. The water which results from such cutting processes comprises tuber protein, and consequently is an aqueous liquid comprising tuber protein in the meaning of step b.

The processing may furthermore comprise one or more steps selected from microfiltration, diafiltration, flocculation, concentration, sulfite addition, glycoalkaloid removal, pulsed electric field treatment. pH adjustment and/or other steps conventional in the tuber industry.

Adjustment of pH can be achieved by various acids and/or bases. Suitable acids are for example hydrochloric acid, citric acid, acetic acid, formic acid, phosphoric acid, sulfuric acid, and lactic acid, and suitable bases are for example sodium or potassium hydroxide, ammonium chloride, sodium or potassium carbonate, oxides and hydroxides of calcium and magnesium.

Glycoalkaloid removal may be performed using appropriate adsorbents as is known in the art, such as for example hydrophobic adsorbents, for example active carbon or a layered silicate. In preferred embodiments, this treatment also has the effect of removing pectines, polyphenols and proanthocyanidines and colored derivatives thereof, such as epicatechins and anthocyanines.

Flocculation may be performed by addition of appropriate flocculants. Appropriate flocculants include for example Ca(OH)₂, cationic or anionic polyacrylamide, chitosan, and carrageenan. In preferred embodiments, a coagulant maybe added to improve the flocculation, preferably a cationic or neutral coagulant or a polymeric silicate. Reference is made in this regard to WO/2016/036243.

Microfiltration (MF) can be performed in order to achieve separation of particles from the liquid. Microfiltration can be carried out with various membranes such as polysulphones, polyvinylidenefluoride (PVDF), polyacrylonitrile (PAN) and polypropylene (PP), as well as with ceramic membranes such as zirconium, titanium membranes or aluminum oxide. MF can be operated either at constant pressure or at constant flow. Pressure can vary between 1.5 bar up to 5 bar. Flux may be between 0 and 350 l·(h·m²)⁻¹, preferably between 45 and 350 l·(h·m²)⁻¹.

MF is preferably performed over membranes having a pore size of 0.1-10 μm, preferably 0.2-4 μm, more preferably 0.3-1.5 μm.

Preferably, the liquid to be treated with microfiltration has a pH of 5.5-7.0, preferably 5.5-6.0, or 6.0 to 7.0. Further preferably, the total soluble solids (TSS, measured as °Bx) is between 3-10°Bx, preferably 4-6°Bx. Further preferably, the conductivity of the liquid is 2.0-30, preferably 2.5-20 mS·cm⁻¹, more preferably 5-20 mS·cm⁻¹. Microfiltration has the effect that the absorbance at 620 nm of the microfiltered liquid preferably becomes lower 0.2, more preferably lower than 0.1. Microfiltration can be operated at a stream split factor (defined as ratio between feed flow and permeate flow (non-dimensional)) between 1.0 and 6.0, preferably 1.0-4.0.

Diafiltration (DF) is a dilution step using water or a salt solution. The main purpose of diafiltration is the removal of small molecules with the permeate, while retaining large molecules such as proteins in the retentate. Preferably, diafiltration is performed using a salt solution. Example of suitable salts are chloride-containing salts such as NaCl, KCl and CaCl₂). The salt solution preferably has a conductivity of 5-50 mS·cm⁻¹, preferably 5-20 mS·cm⁻¹, more preferably 8-15 mS·cm⁻¹. Diafiltration is preferably performed at a dilution rate of 1:1 to 1:10, preferably 1:1 to 1:5.

Preferred molecular weight cutoff values for diafiltration are 5-300 kDa, preferably 2-200 kDa, more preferably 3-150 kDa, such as 5-20 kDa or 5-10 kDa, or 50-150 kDa, preferably 50-100 kDa.

Concentration may be performed by for example ultrafiltration, reverse osmosis or by freeze concentration, as is known in the art.

Sulphite addition is a common step in the potato starch processing industry, used to prevent oxidation of the process streams.

Pulsed electric field treatment is a common step in the potato processing industry, used to modulate properties of potato flesh such as drying rate, strength and flexibility.

In step c) of the present method, the aqueous liquid comprising tuber protein is subjected to a protein isolation step to obtain said tuber protein isolate. Protein isolation from aqueous liquids comprising tuber protein is generally known. Two approaches may be distinguished.

In one embodiment, protein isolation results a native tuber protein isolate. Said native tuber protein isolate may comprise a tuber protease inhibitor isolate, a tuber patatin isolate, or a tuber total isolate, which tuber total isolate comprises a mixture of tuber protease inhibitor and tuber patatin. For example, native tuber patatin isolate can have an isoelectric point of below 5.8, preferably 4.8-5.5, and a molecular weight of more than 30 kDa, preferably more than 35 kDa. Native tuber protease inhibitor isolate can have an isoelectric point above 5.5, preferably above 5.8, and a molecular weight of below 35 kDa, preferably 4-30 kDa.

Native in this context means that protein which is naturally present in tuber as defined above, is extracted from said tuber without significantly affecting the protein. Thus, native protein is not significantly degraded and is not significantly denatured. That is, the amino acid order and the three dimensional structure are essentially intact, in comparison to the protein as it occurs in tuber. Preferred means of obtaining native protein are ultrafiltration, diafiltration, absorption and chromatography.

A much preferred technique for isolating native tuber protein is the use of diafiltration (DF) and/or ultrafiltration (UF). Ultrafiltration and diafiltration separate solutes in the molecular weight range of 5 kDa to 500 kDa and can therefore be used for the separation of protein from low molecular weight solutes. Native tuber protein can thus be obtained from the ultrafiltration or diafiltration retentate.

UF membranes can also be used for DF, and may have pores ranging from 1 to 20 nm in diameter. Preferred UF membranes are anisotropic UF-membranes. Preferably, the ultrafiltration membrane comprises regenerated cellulose, a polyethersulphones (PES) or a polysulphone (PS). An UF membrane can be implemented as tubular, spiral wound, hollow fibre, plate and frame, or as cross-rotational induced shear alter units. Much preferred UF membranes are tubular UF membranes.

The ability of an ultrafiltration membrane to retain macromolecules is traditionally specified in terms of its molecular cut-off (MWCO). A MWCO value of 10 kDa means that the membrane can retain from a feed solution 90% of the molecules having molecular weight of 10 kDa. Preferred MWCO's in the present context are 3-300 kDa membranes, preferably 3-200 kDa, more preferably 3-150 kDa, such as 5-20 kDa or 5-10 kDa, or 50-150 kDa, preferably 50-100 kDa. The aqueous liquid subjected to ultrafiltration preferably has a pH of less than 4.0 or higher than 5.5, in order to avoid swift clogging of the membranes. The aqueous liquid further preferably has a conductivity of 5-20 mS·cm⁻¹, preferably 8-14 mS·cm⁻¹, more preferably 9-13 mS·cm⁻¹.

Where necessary, the conductivity can be adjusted by addition of various salts, such as NaCl, KCl, CaCl₂) or NaHSO₃, preferably NaCl, and/or by addition of acid or base, as defined elsewhere.

A protease inhibitor isolate is preferably obtained using a PES or PS membrane with a molecular weight cut-off of 2-30 kDa, preferably 3-25 kDa or 5-20 kDa. A protease inhibitor isolate can be subjected to UF at a pH of 3.2-7.0, preferably 3.2-4.5.

A patatin isolate is preferably obtained using a PES, a PS or a regenerated cellulose membrane with a molecular weight cut-off of 5-30 kDa, more preferably 5-20 kDa, even more preferably 5-10 kDa. A patatin isolate is preferably subjected to UF at a pH at a pH of <4.0 or a pH of higher than 5.5. After removal of impurities the pH may be increased to pH 8.0-12.0, preferably 9.0-11.0 to enable high fluxes through the membranes and longer performance (operational) times.

A total tuber isolate is preferably obtained using an PES, PS of regenerated cellulose ultrafiltration membrane having a MWCO of 2-50 kDa, more preferably 3-30 kDa, more preferably 5-20 kDa, even more preferably 5-10 kDa. A total tuber isolate is preferably be subjected to UF at a pH of <4.0 or a pH of higher than 5.5. After removal of impurities the pH may be increased to pH 8.0-12.0, preferably 9.0-11.0 to enable high fluxes through the membranes.

In a preferred embodiment, the tuber protein isolate obtained from ultrafiltration has a protein content of more than 75% of the dry matter content. The protein content herein is defined as Kjeldahl nitrogen content times 6.25. Preferably the protein content in the tuber protein isolate is more than 80 wt. %, more preferably more than 90 wt. %, and even more preferably more than 95 wt. %.

In preferred embodiments, the tuber protein isolate as obtained from ultrafiltration is subsequently subjected to diafiltration (DF), in order to (further) remove soluble components. Diafiltration is preferably performed in the same setup as the ultrafiltration, preferably using the same membrane. Diafiltration can be performed against water or a salt solution, for example a salt solution comprising NaCl, KCl, and/or CaCl₂, such as at a conductivity of 5-20 mS·cm⁻¹, preferably 8-14 mS·cm⁻¹, more preferably 9-11 mS·cm⁻¹. Preferred pH values for diafiltration are as described above under UF. Diafiltration is performed at dilution rate of 1:1 to 1:10 (ultrafiltration retentate:water or salt solution), preferably 1:5, more preferably 1:4, 1:3 or 1:2. This results in a diafiltration retentate comprising as a percentage of dry matter at least 75 wt. % native potato protein, and preferably at most 0.05 wt. % the total of glucose, fructose and sucrose and at most 1 wt. % potato free amino acids. If diafiltration is performed against a salt solution, it is preferred to concentrate the diafiltration retentate using ultrafiltration.

A further much preferred technique for protein isolation is absorption, such as by mixed mode chromatography, which may be achieved for example as described in EP 2 083 634, WO2014/011042, or by other methods known in the art.

Native tuber protein may furthermore be isolated by chromatography, such as for example cation exchange chromatography or anion exchange chromatography, as is known in the art. Other techniques to isolate native tuber protein include isoelectric focusing, isoelectric precipitation and complexation, as is known in the art.

In another embodiment, protein isolation comprises a step of denaturing tuber protein and subsequently isolating denatured tuber protein. Suitable techniques are known in the art, and include preferably acid coagulation, heat coagulation, isoelectric precipitation and complexation. It is generally known that isoelectric precipitation and complexation result in a mixture of native and denatured protein, thus allowing for isolation of both native and denatured protein.

Coagulation means subjecting protein to denaturing conditions so as to obtain denatured (coagulated) protein. Suitable technique to achieve this are subjecting the protein to heat, or subjecting the protein to acid. This results in a suspension of coagulated protein, which may subsequently be filtered, cycloned, decanted or otherwise separated to isolate the coagulated protein from the aqueous liquid. These techniques are well known in the art. Acid coagulation and heat coagulation are much preferred approaches to obtain a tuber protein isolate according to step c.

Further preferred techniques are isoelectric precipitation and complexation, which may also result in a denatured tuber protein isolate according to step c. These techniques, also, are generally known.

At any point in the recited method, the pH may be adjusted by addition of acid or base. Suitable acids are for example hydrochloric acid, citric acid, acetic acid, formic acid, phosphoric acid, sulfuric acid, and suitable bases are for example sodium or potassium hydroxide, ammonium chloride, sodium or potassium carbonate, oxides and hydroxides of calcium and magnesium. Adjustment of the pH may serve various purposes: it may lead to precipitation of certain constituents of the aqueous liquid, which may subsequently be removed by a step of solids removal, such as filtration, microfiltration cycloning, and the like. Adjustment of the pH may furthermore increase solubility of a protein fraction, which can lead to an improved ultrafiltration and/or diafiltration process. And pH also influences protein stability, thus allowing for process control.

In further preferred embodiments, the tuber peel composition is separately subjected to one or more further processing steps. This has the advantage that a second tuber protein isolate may be obtained. This second tuber protein isolate is a protein isolate derived from the tuber peel composition. It has been found that said second tuber protein isolate has a different composition, most notably a different amino acid composition, than the tuber protein isolate derived from the (unpeeled) flesh of tuber. The second tuber protein isolate comprises increased quantities of the essential amino acids threonine, leucine, isoleucine, methionine and phenylalanine relative to a tuber protein product derived from unpeeled tubers. This can be of value, in particular when said second tuber protein product is used in human food applications.

Further processing steps to obtain tuber peel derived products may be similar to those described above for potato flesh. Further processing steps may thus be selected from the group of flocculation, filtration, glycoalkaloid removal, protein isolation, protein hydrolysis, microfiltration step, drying, and the like. Protein isolation may be achieved by acid coagulation, heat coagulation, isoelectric precipitation, complexation, ultrafiltration, diafiltration, absorption or chromatography, as described above.

In a preferred embodiment, the peeled tuber and tuber peel derived products are processed separately, to obtain a first tuber protein isolate derived from the tuber and a second tuber protein isolate derived from the tuber peel. This means that the aqueous liquids comprising tuber proteins obtained by processing the peeled tuber or tuber peel, are preferably not combined and further processed together, during any stage of the methods for obtaining tuber protein isolate, as described herein.

Advantageously, the first and second tuber protein isolate products have distinguished compositions, in particularly distinguished amino acid compositions. This can be beneficial, since different applications, in particular food applications, require different amino acid compositions, for example for taste or medical purposes. Thus, processing the peeled tuber and tuber peel separately in a method according to the invention, allows to obtain a first and second tuber protein isolate product with distinct amino acid composition.

It is preferred that the present method is applied on an industrial scale. Thus, the present method is preferably operated to result in at least 5 kg of protein per hour, more preferably at least 25 kg protein per hour, even more preferably at least 50 kg protein per hour.

It is an advantage of the present method that the obtained crude protein composition is considerably more clean than other tuber-derived protein compositions in crude form. Crude, in this regard, refers to the protein composition as obtained directly from the isolation process. Crude thus refers to the protein composition prior to any cleaning or purification step which can be executed on the isolated crude protein in order to make it suitable for its intended application, for example for use in animal feed, or for use in human food applications.

It is an advantage that the crude protein obtained from the present method requires considerably less cleaning and/or purification, such as glycoalkaloid removal, chlorogenic acid removal, removal of sugars (defined as the total of glucose, sucrose and fructose), removal of salts, in particular potassium salts, and/or removal of free amino acids.

This advantageously leads to a reduction in costs, labor and time required to obtain a pure tuber protein isolate suitable for further use. Further, processing a rather clean crude protein advantageously causes less equipment scaling and fouling due to the presence of fewer impurities and thus results in an increased equipment lifetime. In addition, purifying a more clean crude protein requires the use of fewer chemicals and other materials, thereby producing less waste, which significantly reduces the environmental burden.

Therefore, the invention further relates to a crude tuber protein product, comprising less than 80 mg/kg sugars, selected from the group of sucrose, glucose and fructose, preferably less than 60 mg/kg sugars, more preferably less than 45 mg/kg, in particular less than 30 mg/kg. Further, the crude tuber protein preferably comprises less than 1500 mg/kg, preferably less than 1200 mg/kg, even more preferably less than 1000 mg/kg, in particular less than 500 mg/kg glycoalkaloids.

In particular, processing a crude tuber protein that has a low sugar content, in particular a low sucrose, glucose and fructose content, is advantageous, because sugars are notoriously difficult to remove from protein compositions, in particular from coagulated protein products. Further, the presence of sugars in protein products reduce their organoleptic properties such as taste and mouthfeel, which decreases the suitability of these proteins for human food applications.

Likewise, the presence of glycoalkaloids in tuber protein products also reduces organoleptic properties including taste and mouthfeel of the proteins, which is undesired.

Thus subjecting a crude protein with a low sugar and low glycoalkaloid content as defined above, to further purification or cleaning steps to obtain a pure protein isolate, significantly improves process efficiency with all associated benefits as described elsewhere.

It is a further advantage that the crude protein obtained from the present method has a low microbiological count. The microbiological count can be determined by total viable aerobic count plating according to ISO 4833-1/2013, of below 10⁴ CFU/gram, preferably below 10³ CFU/gram.

For the purpose of clarity and a concise description features are described herein as part of the same or separate embodiments, however, it will be appreciated that the scope of the invention may include embodiments having combinations of all or some of the features described. The invention will now be illustrated by the following, non-limiting examples.

### EXAMPLES

Protein concentrations were determined using a CEM Sprint Rapid protein analyzer that was calibrated against Kjeldahl measurements. Sprint measures the loss of signal of a protein-binding dye. The higher the loss, the more protein is present. This system is calibrated using Kjeldahl measurements on extensively dialysed protein samples so that all nitrogen that is detected will originate from protein and not from free amino acids, peptides or other nitrogen sources. The nitrogen-number is then converted into a protein content by multiplying with 6.25.

Amino acid analysis of the potato protein fractions was performed using HPLC-UV/FLU and/or Biochrom amino acid analyzers using classical ion-exchange liquid chromatography with post-column Ninhydrin derivatisation and photometric detection, as is known in the art.

The sugar content was determined by enzymatic analysis as published by Megazyme (Ireland). This method makes use of a sucrose/fructose/D-glucose assay kit (art no. K-SUFRG), and comprises an UV-method for the determination of sucrose, D-fructose and D-glucose in foodstuffs, beverages and other materials.

Glycoalkaloids (total glycoalkaloids or TGA) were determined essentially according to the method of Laus and coworkers (Laus M. C., Klip G. & Giuseppin M. L. F. (2016) Food Anal. Methods 10(4) “Improved Extraction and Sample Cleanup of Tri-glycoalkaloids α-Solanine and α-Chaconine in Non-denatured Potato Protein Isolates”).

Briefly, samples were dissolved or diluted in 5% acetic acid solution containing 20 mM of heptane sulfonic acid sodium salt (VWR 152783K) for at least 2 hours. Insoluble materials were removed by centrifugation at 9000 g at ambient temperature (Heraeus Multifuge 1 SR, rotor 75002006) and the supernatant was filtered over a GHP Acrodisc 13 mm Syringe Filter with 0.45 μm GHP Membrane (PALL PN 4556T) directly into a 1.5 mL HPLC vial (VWR 548-0004) and capped with an aluminium ci 11 mm, rubber/butyl/TEF cap (VWR 548-0010). Samples were introduced automatically onto a SPE column (Oasis HLB prospect-2/Symbiosis cartridge 2.0×10 mm particle size 30 μm) via a Robotlon online SPE system (Separations). The glycoalkaloids were eluted onto a Hypersil ODS C18 (250 mm×4.6 mm 5 μm) column and separated using 50% acetonitrile/phosphate buffer pH 7.6. Analytes were detected using Smartline UV detector 2520 (Knauer) and quantified on a calibration curve prepared from purified glycoalkaloids (α-solanine, Carl Roth 4192.1 and α-chaconine Carl Roth 2826.1)

Microbiological characteristics were determined according to ISO 4833-1/2013.

Metals were determined by Inductive-Coupled Plasma Mass Spectrometry (ICP-MS) according to ISO 17294-2:2016.

Ash was determined by incineration of the sample at 550° C. and weighing the residue.

### Example 1

Two 10 kg batches of potatoes (cv. Novano, from Averis Seeds, NL, and cv. Bildstar, purchased in a local supermarket) were divided in two 5 kg portions. One portion was peeled by mechanical abrasion on a peeler (Machinefabriek Duurland, NL) while the other was processed unpeeled.

All portions were separately cut into pieces and grated on a Braun kitchen centrifuge to obtain a potato juice. The juice was decanted from the starch and fiber fraction, filtered over a Whatman filter paper and subsequently passed over an 90 micrometer sieve.

The juices of the two varieties of peeled and unpeeled potatoes obtained in this way were heated in a boiling water bath until the temperature reached 80° C., and kept at this temperature for an additional ten minutes to coagulate the protein. The protein was then recovered via centrifugation (ambient temperature, 4700 rpm for 10 minutes on a Hereaus Multifuge SR).

The protein recovered in this way was frozen and analyzed for glycoalkaloids, amino acid composition, metals, sugars and microbiological characteristics.

### Results

Amino acid analysis of the potato protein fractions revealed that peeling resulted in a number of differences in chemical composition of the protein (table 1); in both Novano and Bildstar, peeling resulted in elevated levels of aspartic acid and asparagine, glutamic acid and glutamine, tyrosine, proline and arginine.

In contrast, peeling reduced the levels of the essential amino acids threonine, isoleucine, leucine, lysine and the conditionally essential amino acid cysteine, as well as the level of glycine.

TABLE 1
Composition of potato protein from peeled and unpeeled potatoes (normalised
protein composition, in g amino acid, per kg protein).

| Amino | Peeled | Unpeeled | Peeled | Unpeeled | Increase after peeling (%) | |
|---|---|---|---|---|---|---|
| acid | Bildstar | Bildstar | Novano | Novano | Bildstar | Novano |
| Asx | 134 | 143 | 127 | 127 | 9.4 | 0.4 |
| Tyr | 46 | 55 | 60 | 57 | 8.9 | 2.7 |
| Arg | 47 | 47 | 47 | 46 | 0.8 | 1.3 |
| Glx | 100 | 102 | 102 | 101 | 2.6 | 1.1 |
| Pro | 46 | 47 | 46 | 45 | 0.7 | 0.6 |
| Gly | 50 | 49 | 48 | 49 | −1.4 | −0.5 |
| Ala | 41 | 41 | 42 | 43 | 0.0 | −0.9 |
| Val | 64 | 61 | 62 | 62 | −3.4 | 0.2 |
| Ser | 55 | 56 | 53 | 54 | 0.9 | −1.5 |
| Cys | 21 | 19 | 19 | 20 | −2.3 | −0.6 |
| Trp | 17 | 18 | 17 | 17 | 1.1 | −0.1 |
| His | 19 | 19 | 20 | 21 | −0.3 | −0.1 |
| Lys | 72 | 72 | 73 | 73 | −0.1 | −0.2 |
| Met | 18 | 16 | 20 | 20 | −2.1 | 0.3 |
| Phe | 62 | 60 | 62 | 62 | −1.7 | 0.3 |
| Ile | 54 | 50 | 50 | 51 | −4.1 | −0.7 |
| Leu | 96 | 95 | 95 | 96 | −1.5 | −1.1 |
| Thr | 59 | 51 | 55 | 56 | −7.5 | −1.2 |

Amino acids printed in bold are essential amino acids in humans.

TABLE 2
chemical composition of peeled and unpeeled Bildstar potatoes

| [mass per kg dry matter] | Bildstar Peeled | Bildstar Unpeeled |
|---|---|---|
| Crude protein(Kjeldahl, 6.25; g/kg) | 756 | 762 |
| TGA (mg/kg) | 576 | 1868 |
| Crude ash (550° C; g/kg) | 50 | 79 |
| Total sugars (g/kg) | 28.9 | 43.3 |
| Saccharose (g/kg) | 10.0 | 14.0 |
| Fructose (g/kg) | 9.4 | 15.2 |
| Glucose (g/kg) | 9.4 | 14.0 |
| Calcium (g/kg) | 0.4 | 0.7 |
| Iron (mg/kg) | 161.1 | 213.4 |
| Potassium (g/kg) | 22.4 | 36.1 |
| Copper (mg/kg) | 34.4 | 56.7 |
| Magnesium (g/kg) | 1.2 | 1.8 |
| Sodium (g/kg) | 0.2 | 0.3 |
| Zinc (mg/kg) | 42.8 | 52.4 |
| Aluminium (mg/kg) | not detected | 61.0 |
| Cadmium (mg/kg) | 0.41 | 0.46 |
| Nitrate (mg/kg) | 550 | 1159 |

Table 2 shows that peeling results in a potato protein with significant and relevant lower levels of contaminants such as TGA, sugars and Nitrate

### Example 2

The results from Example 1 appear to show that the effect of peeling is stronger for Bildstar potatoes than for Novano potatoes. This is not considered accurate. The used Novano potato were of rather irregular shape, with many dents, crevices and holes, and peeling was therefore not quite as efficient as for the regularly shaped Bildstar potatoes. In order to confirm that peeling has a similar effect for any potato variety, Novano potatoes (2×1 kg) were obtained, and one batch was peeled by hand using a knife, so as to follow all irregularities in shape and effect full removal of the skin and part of the flesh below, also in steep dents and crevices. The other batch was processed unpeeled.

To verify the effect of peeling, ash and potassium contents were determined for peeled and unpeeled potatoes. The results are shown in Table 3, and support the idea that also for potatoes with large quantities of crevices and dents, efficient peeling reduces the quantities of species which apparently are present in the outer layer. Thus peeling has the effects described herein for any potato variety.

TABLE 3
Ash and potassium contents of peeled
and unpeeled Novano potatoes.

| | | Unpeeled | Peeled |
|---|---|---|---|
| Protein content in | g/kg | 778 | 806 |
| dry matter | | | |
| Ash | g/kg | 91 | 75 |
| | protein | | |
| Potassium | g/kg | 41 | 33 |
| | protein | | |

1. A method for obtaining a tuber protein isolate, comprising
a) peeling at least one tuber, thereby obtaining at least one peeled tuber and a tuber peel composition;
b) processing said at least one peeled tuber to obtain an aqueous liquid comprising tuber protein;
c) subjecting said aqueous liquid to a protein isolation step to obtain said tuber protein isolate.

2. A method according to claim 1, wherein said peeling comprises mechanical peeling and/or steam peeling.

3. A method according to claim 1, wherein said processing to obtain the aqueous liquid comprises pulping, mashing, rasping, grinding, pressing or cutting of the at least one peeled tuber.

4. A method according to claim 1, wherein said processing further comprises one or more steps selected from starch removal, microfiltration, flocculation, diafiltration, concentration, sulphite addition, glycoalkaloid removal, pH adjustment and/or pulsed electric field treatment.

5. A method according to claim 1, wherein said protein isolation step comprises acid coagulation, heat coagulation, isoelectric precipitation, complexation, ultrafiltration, diafiltration, absorption or chromatography.

6. A method according to claim 1, wherein the method is operated to result in at least at least 5 kg of protein per hour.

7. A method according to claim 1, wherein said tuber comprises potato, sweet potato, cassava, yam or taro.

8. A method according to claim 1, wherein said tuber protein isolate comprises native tuber protein, comprising a tuber protease inhibitor isolate, a tuber patatin isolate, or a tuber total isolate comprising a mixture of protease inhibitor and patatin.

9. A method according to claim 1, wherein the tuber peel composition is subjected to the steps of
a) processing said tuber peel composition to obtain a second aqueous liquid comprising tuber protein;
b) subjecting said second aqueous liquid to a second protein isolation step to obtain a second tuber protein isolate.

10. A method according to claim 9, wherein said processing comprises one or more processing steps, selected from the group of pulping, mashing, rasping, grinding, pressing or cutting of the at least one peeled tuber, and furthermore comprises one or more steps selected from microfiltration, flocculation, diafiltration, concentration, sulphite addition, glycoalkaloid removal, pH adjustment and/or pulsed electric field treatment to obtain said second aqueous liquid.

11. A method according to claim 9, wherein said second protein isolation step comprises acid coagulation, heat coagulation, isoelectric precipitation, complexation, ultrafiltration, diafiltration, absorption or chromatography.

12. A crude tuber protein product, comprising less than 30 mg/kg sugars, selected from the group of sucrose, glucose and fructose, and less than 1000 mg/kg glycoalkaloids.

13. A crude tuber protein product according to claim 12, having a microbiological count, as determined by total viable aerobic count plating according to ISO 4833-1/2013, of below 10⁴ CFU/gram.

14. A crude second tuber protein product, comprising increased quantities of the essential amino acids threonine, leucine, isoleucine, methionine and phenylalanine relative to a tuber protein product derived from unpeeled tubers.

15. A method according to claim 3, wherein the pulping, mashing, rasping, grinding, pressing, or cutting of the at least one peeled tuber comprises a combination with water.

16. A method according to claim 7, wherein the tuber comprises potato.

17. A method according to claim 11, wherein the second protein isolation step comprises a drying step.

18. A crude tuber protein product according to claim 13, having a microbiological count, as determined by total viable aerobic count plating according to ISO 4833-1/2013, of below 103 CFU/gram.
